(19) United States
(12) Patent Application Publication
(10) Pub. No.: US 2016/0119788 A1
(43) Pub. Date: Apr. 28, 2016

(54) AUTHENTICATION OF BROWSER-BASED SERVICES VIA OPERATOR NETWORK

(71) Applicant: QUALCOMM Incorporated, San Diego, CA (US)

(72) Inventors: Giridhar Dhati Mandyam, San Diego, CA (US); Arungundram Chandrasekaran Mahendran, San Diego, CA (US); Anand Palanigounder, San Diego, CA (US)

(21) Appl. No.: 14/521,373

(22) Filed: Oct. 22, 2014

(51) Int. Cl. H04W 12/08; H04L 29/06; H04W 12/06

(52) U.S. Cl. CPC H04W 12/08; H04W 12/06; H04L 63/0876

(57) ABSTRACT

An example method of determining a level of service to allocate for a browser-based session includes receiving, at an operator core network, a request to establish a browser-based session for a web service. The request is from a browser executing on a user equipment (UE). The method also includes identifying an attribute value of an attribute assigned to the UE and determining, based on the attribute value assigned to the UE, whether the UE is currently registered with the operator core network. The method further includes determining, based on whether the UE is currently registered with the operator core network, a level of service to allocate for the browser-based session.

### FIELD OF DISCLOSURE

The present disclosure generally relates to authentication, and more particularly to authentication of browser-based services running on a mobile device.

### BACKGROUND

Telecommunications providers provide subscribed users with access to services over a network and desire to protect their services from unauthorized access. With wireless technologies becoming more popular and convenient for users, telecommunications providers have begun to move away from traditional network architectures reliant on older time division multiplex (TDM) facilities and into an all-Internet Protocol (IP) infrastructure, Although many telecommunications providers use the IP in their traditional telecommunications networks, implementation standards do not clearly define how networks are to communicate with one another or how to authenticate in an IP world. The IP Multimedia Subsystem (IMS) architecture defines one common protocol standard to be used network-wide for all sessions within the wireless network.

The Generic Bootstrapping Architecture (GBA) is a method standardized by the Third Generation Partnership Project (3GPP) to allow browser-based services (e.g., WebRTC) to leverage SIM-based authentication with operator networks. GBA allows IMS authentication to be leveraged as part of web service authentication. In GBA parlance, the web service provider is known as the Network Application Function (NAF), which authenticates the end user in a browser-based session using typical Hypertext Transfer Protocol (HTTP) procedures, but only from a web perspective (e.g., leveraging web identity providers). The NAF, however, does not allow the web service to continue until user-specific keys derived from IMS AKA (Authentication and Key agreement) have been completed. Therefore the mobile device is directed to complete IMS authentication with a network element known as the Bootstrapping Server Function (BSF), retrieve the necessary keying information, and pass that along to the browser so that it can complete authentication with the NAF.

GBA is an acceptable way to integrate IMS authentication with browsers for web-based services. GBA, however, uses browser extensions to existing browsers that have not proven to be commercially viable. Accordingly, GBA would be most likely extended into the browser via a “coupling” of a GBA client and the browser, perhaps through the browser plug-in architecture.

### BRIEF SUMMARY

It may be desirable to leverage an authentication mechanism (e.g., IMS AKA) without extending the browser in the context of authenticating or determining a level of service to provide to a real-time peer-to-peer communication session. Additionally, telecommunications providers may want to guarantee a particular level of service to subscribed users. Methods, systems, and techniques for determining a level of service to allocate for a browser-based session are provided.

According to some embodiments, a method of determining a level of service to allocate for a browser-based session includes receiving, at an operator core network, a request to establish a browser-based session for a web service. The request is from a browser executing on a user equipment (UE). The method includes identifying an attribute value of an attribute assigned to the UE, The method further includes determining, based on the attribute value assigned to the UE, whether the UE is currently registered with the operator core network. The method also includes determining, based on whether the UE is currently registered with the operator core network, a level of service to allocate for the browser-based session.

According to some embodiments, a system for determining a level of service to allocate for a browser-based session includes an attribute module that receives, at an operator core network, a request to establish a browser-based session for a web service. The attribute module identifies an attribute value assigned to a user equipment (UE) and determines, based on the attribute value assigned to the UE, whether the UE is currently registered with the operator core network. The request is from a browser executing on the UE. The system also includes an allocator that determines, based on whether the UE is currently registered with the operator core network, a level of service to allocate for the browser-based session.

According to some embodiments, a computer-readable medium has stored thereon computer-executable instructions for performing operations including: receiving, at an operator core network, a request to establish a browser-based session for a web service, the request being from a browser executing on a user equipment (UE); identifying an attribute value of an attribute assigned to the UE; determining, based on the attribute value assigned to the UE, whether the UE is currently registered with the operator core network; and determining, based on whether the UE is currently registered with the operator core network, a level of service to allocate for the browser-based session.

According to some embodiments, an apparatus for determining a level of service to allocate for a browser-based session includes means for receiving a request to establish a browser-based session for a web service, the request being from a browser executing on a user equipment (UE); means for identifying an attribute value of an attribute assigned to the UE; means for determining, based on the attribute value assigned to the UE, whether the UE is currently registered with the operator core network; and means for determining, based on whether the UE is currently registered with the operator core network, a level of service to allocate for the browser-based session.

### BRIEF DESCRIPTION OF THE DRAWINGS

The accompanying drawings, which form a part of the specification, illustrate embodiments of the invention and together with the description, further serve to explain the principles of the embodiments. In the drawings, like reference numbers may indicate identical or functionally similar elements. The drawing in which an element first appears is generally indicated by the left-most digit in the corresponding reference number.

FIG. 1 is a block diagram illustrating a system for authenticating a web service session via an operator core network, according to some embodiments.

FIG. 2 is a partial call setup signaling diagram illustrating the use of header information in a web request to process the request, according to some embodiments.

FIG. 3 is a simplified flowchart illustrating a method for determining a level of service to allocate for a browser-based session, according to some embodiments.

FIG. 4 is a simplified flowchart illustrating a method for determining a level of service to allocate for a browser-based session, according to some embodiments.

FIG. 5 is a block diagram illustrating a wireless device including a digital signal processor, according to some embodiments.

### DETAILED DESCRIPTION

I. Overview

II. Example System Architecture
A. Register User Equipment with the Operator Core Network
B. Leverage Registration Status to Determine a Level of Service to Allocate for a Browser-Based Session

III. Header Enrichment
A. Initiate Real-Time Communication Session for Web Service
B. Insert Attribute Value into Header
C. Match Attribute Value with Currently Registered User Equipment
D. Level of Service Based on Registration Status of User Equipment

IV. IP Address Tied to Web Traffic

V. Example Method

VI. Example Wireless Device

### I. Overview

It is to be understood that the following disclosure provides many different embodiments, or examples, for implementing different features of the present disclosure. Some embodiments may be practiced without some or all of these specific details. Specific examples of components, modules, and arrangements are described below to simplify the present disclosure. These are, of course, merely examples and are not intended to be limiting.

The present disclosure provides techniques to determine a level of service to allocate for a browser-based session by taking advantage of network-level processing without modifying the browser. A telecommunications provider may determine to allocate different levels of services to users, where an allocated level of service is based on whether the user's device is currently registered with the telecommunications provider. The telecommunications provider may tie a previous authentication of the user's device (e.g., using IMS AKA) with browser traffic. If the browser traffic is associated with a request to initiate a real-time peer-to-peer communication session and the user's device is currently registered with the telecommunications provider, the telecommunications provider may determine a particular level of service to offer the user for the real-time peer-to-peer communication session.

### II. Example System Architecture

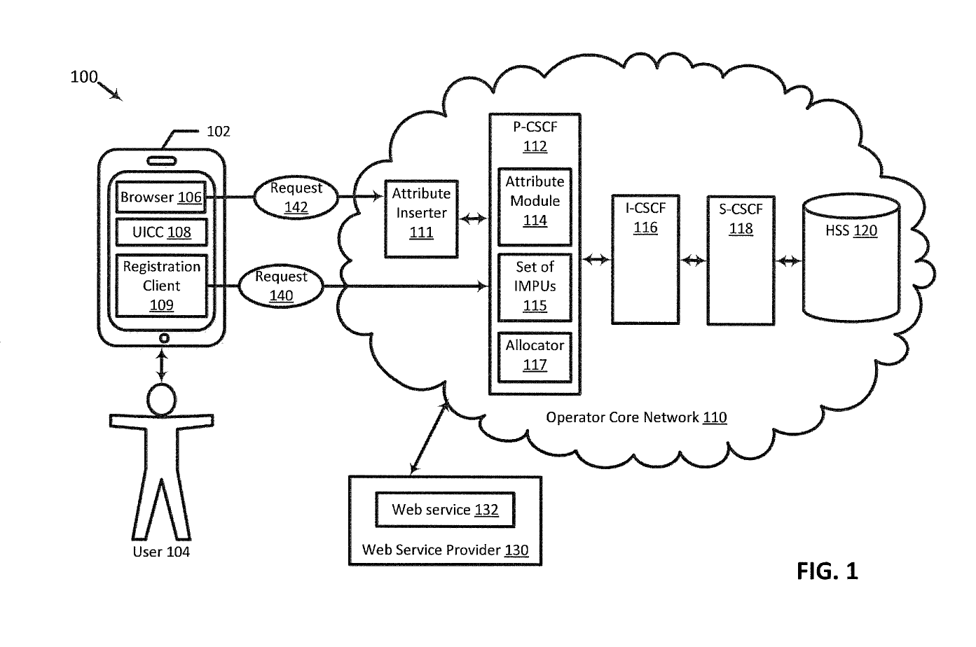

FIG. 1 is a block diagram illustrating a system 100 for authenticating a web service session via an operator core network, according to some embodiments. System 100 includes user equipment 102 in communication with an operator core network 110. User equipment 102 is a computing device that is used by an end user 104 to communicate with operator core network 110. In an example, user equipment 102 may be a cellular-enabled device such as a hand-held telephone (e.g., smartphone), personal digital assistant (PDA), tablet, or laptop. Other devices are within the scope of the present disclosure.

User equipment 102 includes a browser 106, which is a client application capable of accessing and displaying webpages on a display of user equipment 102. For example, browser 106 may send a request to access a web service 132 provided by a web service provider 130, and display the requested webpages on the display of user equipment 102. User 104 may point the browser to a webpage by, for example, typing a uniform resource location (URL) of the webpage in the address bar of the browser or selecting a hyperlink that causes web service provider 130 to provide the webpage.

In some examples, web service 132 is an application that provides two-way real-time communications capability between two peers. In an example, web service 132 is WebRTC (Web Real-Time Communications), which is an open project that aims to add real-time communications capabilities to Web browsers via a JavaScript Application Programming Interface (API). WebRTC offers web application developers the ability to write rich, real-time multimedia applications on the Web, without requiring plugins, downloads, or installs. The WebRTC technology enables web developers to establish real-time communications in a peer-to-peer sense between browser-based applications regardless of the relative location of the peers (e.g., on the same device, in the same private network, both behind distinct firewalls, etc.).

Operator core network 110 may be used for providing voice and multimedia services over different network topologies offering IP connectivity. In an example, operator core network 110 may be used for providing voice services over Long-Term Evolution (LTE). Operator core network 110 may communicate using Session Initiation Protocol (SIP) messaging. SIP is a signaling, presence, and instant messaging protocol developed to set up, modify, and tear down multimedia sessions.

In some embodiments, operator core network 110 is the IP Multimedia Subsystem (IMS) network and is responsible for controlling user registration, initiating and managing sessions, linking to applications, and providing information to session support tasks such as billing and applications. In 3GPP-defined networks, the IMS network forms the core network offering. Additionally, WebRTC may be interoperable with the IMS core network. In an example, IMS interoperability may be achieved by providing new core network elements that provide hosting of the WebRTC application (e.g., a webpage), a signaling server to mediate communication between peers and translate client signaling over a browser-compatible transport (e.g., HTTP-based) to an IMS-friendly SIP (Session Initial Protocol) transport, and a transcoding media gateway that accounts for different coder and/or decoder (codec) usage among peers.

The IMS network includes call state control functions (CSCFs) that are functional entities that may constitute applications, deployed on an IP host, with the IP hosts connected to the operator's IP infrastructure. One host may include more than one functional entity, and functional entities may co-reside in a server or occupy separate servers as desired for a particular network size and shape. When functional entities reside in the same computing device, IP messages may traverse a shorter path.

A. Register User Equipment with the Operator Core Network

If user 104 is subscribed to operator core network 110, user 104 may be referred to as a subscriber and user equipment 102 is able to gain access to IP multimedia services while registered with operator core network 110. In FIG. 1, user equipment 102 includes universal integrated circuit card (UICC) 108 and registration client 109, which may be used to register user equipment 102 with operator core network 110. In an example, operator core network 110 is the IMS network, and user equipment 102 is an IMS-enabled device. In this example, registration client 109 is an IMS client that communicates with operator core network 110 to register user equipment 102 with the IMS network.

User equipment 102 may register with operator core network 110 using a variety of registration techniques. In an example, user equipment 102 registers with the IMS network using IMS Authentication and Key Agreement (AKA). For brevity, the disclosure may describe IMS AKA as being the registration mechanism that authenticates and registers user equipment 102, but this is not intended to be limiting and it should be understood that other registration mechanisms that register user equipment 102 with the operator core network 110 are within the scope of the disclosure.

In IMS AKA, when user 104 switches on user equipment 102, registration client 109 may automatically initiate communications with operator core network 110 to register with it using information contained in UICC 108. UICC 108 is a physically secure device that can be inserted and removed from user equipment 102, and may contain one or more IP multimedia services identity modules (ISIMs) and/or universal subscriber identity modules (USIMs). ISIM is an application residing on UICC 108 and stores IMS-specific subscriber data mainly provisioned by an IMS operator. The subscriber data contains subscriber credentials, which may be derived from UICC 108 and used when a user registers a device with the IMS network. For example, the information contained in UICC 108 may include an IP Multimedia Private Identity (IMPI), one or more IP Multimedia Public Identities (IMPUs), and a long-term secret key used to authenticate and calculate cipher keys. The IMPI and IMPU are special subscriber credentials that are derived from UICC 108. An example of an IMPU is a telephone number that is assigned to user equipment 102.

Operator core network 110 includes one or more P-CSCFs (proxy CSCFs) 112, one or more I-CSCFs (interrogating CSCFs) 116, one or more S-CSCFs (serving CSCFs) 118, and one or more home subscription servers (HSS) 120. User equipment 102 may initiate the registration by sending a REGISTER request 140 including the IMPI and the IMPU(s) to operator core network 110. When user equipment 102 sends a signaling message to operator core network 110, the message may be sent to P-CSCF 112. The IMS network architecture resolves IP-based signaling through the use of the P-CSCF, which is a network entity through which user equipment 102 can register and signal for calls. P-CSCF 112 is the user-to-network proxy, and all SIP signaling to and from end user 104 runs via a P-CSCF of the IMS network. The P-CSCF may be a unique process running within operator core network 110. When a user connects to operator core network 110, each individual user may be assigned a P-CSCF. As such, a P-CSCF assigned to user equipment 102 may be different from a P-CSCF assigned to another user equipment.

P-CSCF 112 receives REGISTER request 140 and forwards it to I-CSCF 116. I-CSCF 116 may forward an initial SIP request to a S-CSCF when the initiator of the request does not know which S-CSCF should receive the SIP request. Generally, I-CSCF 116 contacts HSS 120 to obtain the address of the S-CSCF that will receive and process the SIP request. An HSS is the main subscriber database for IMS and provides access to subscriber data (subscription data), which is distributed through the network, to designated functional entities (nodes). In an example, S-CSCF 118 is assigned to user equipment 102, and I-CSCF 116 forwards the registration request to S-CSCF 118.

Operator core network 110 performs operations to register user equipment 102. When IMS AKA completes and operator core network 110 authenticates user equipment 102, S-CSCF 118 registers user equipment 102 with operator core network 110 and stores the registration information in a registry in HSS 120, Additionally, P-CSCF 112 receives from HSS 120, via S-CSCF 118, a set of IMPUs 115 for the subscriber. Set of IMPUs 115 may include attribute information that identifies user equipment 102, as discussed further below. After user equipment 102 is registered with operator core network 110, user 104 may access the services of operator core network 110. For example, services such as voice calls using a cellular network, push to talk, presence, voice and video sessions, messaging, and multiplayer games may be available to the user.

Using IMS AKA to authenticate user equipment 102, operator core network 110 takes advantage of subscriber credentials contained in UICC 108, which is considered to be a physically secure device because the derived subscriber credentials are difficult to spoof. Browsers typically do not have access to UICC 108 and in particular, to the subscriber credentials derived from UICC 108. In fact, it may be undesirable to modify and/or allow browsers to have access to the subscriber credentials for security reasons. For example, a message including subscriber credentials that is sent over the air from a web application is an inherently unsecure message. Additionally, it may be undesirable to allow browsers to obtain the subscriber credentials so as to prevent malicious websites from grabbing the subscriber credentials via the browser and cloning them, possibly resulting in user 104 being wrongfully billed by operator core network 110. Thus, modifying browsers and webpages at the application layer may come with security concerns.

### B. Leverage Registration Status to Determine a Level of Service to Allocate for a Browser-Based Session

The operator of operator core network 110 may desire to allocate different levels of service to subscribed users based on whether they are currently registered with operator core network 110. For example, the operator may be a cellular provider that provides a particular level of service based on the subscribed user's data plane. For example, the cellular provide may want to provide a higher quality of service to its subscribed users who pay over $85/month and provide a lower quality of service to its subscribed users who pay less than that amount. Additionally, the operator may want to verify that the user equipment making the request is owned by a subscribed user and registered with operator core network 110.

It may be advantageous to leverage operator core network 110's knowledge of user equipment 102 and its current registration status to determine a level of service to allocate to browser 106 for a browser-based session. In an example, operator core network 110 is the IMS network, and the operator is a cellular network provider. The cellular network provider may run IMS over the cellular network provider's cellular network and task the IMS network with allocating services to subscribers and billing for services. Web service 132 may be a real-time communication service, and the browser-based session may be a real-time peer-to-peer communication session.

The operator may want to allocate a particular level of service for the web service session. For example, the operator may want to guarantee a QoS to particular subscribers. The particular level of service may be the same or different level of service that the subscriber would have for a typical voice call. Operator core network 110 may offer transcoding services, interoperability with other operator core network subscribers, and cellular quality-of-service (QoS) for authenticated web service sessions. Additionally, the operator may want to charge the subscriber for the web service session.

While it may be possible to support a multimedia service using today's IP networks, it is challenging for operator core network 110 to accurately bill for that service, and to monitor the QoS for that service. Session control, security, and charging are all important aspects for service delivery.

As discussed, the subscriber credentials derived from UICC 108 may be used to register user equipment 102 with operator core network 110. Operator core network 110 may indirectly use the subscriber credentials that were used to authenticate and register user equipment 102 to determine a level of service to allocate for the browser-based session and/or authenticate the web service. In this example, operator core network 110 may determine the current registration status of user equipment 102 and determine, based on whether user equipment 102 is currently registered with the operator core network, a level of service to allocate for the browser-based session for web service 132.

In an embodiment, operator core network 110 receives a web request 142 to establish a browser-based session via web service 132. Request 142 may be sent from browser 106 executing on user equipment 102 using HTTP. Operator core network 110 may identify, based on request 142, an attribute value assigned to user equipment 102. Operator core network 110 may determine, based on the attribute value assigned to user equipment 102, whether user equipment 102 is currently registered with operator core network 110. Operator core network 110 may determine, based on whether user equipment 102 is currently registered with operator core network 110, a level of service to allocate for the browser-based session.

### III. Header Enrichment

Browser 106 may send request 142 to operator core network 110, where request 142 is a request to establish a browser-based session for web service 132. Request 142 may be an HTTP request including header information. In some embodiments, operator core network 110 receives and processes request 142 using header enrichment. Header enrichment may include inserting data into the header section of the request in an HTTP transaction originating from a browser running on a cellular-enabled device. The header section may include one or more header fields that are name-value pairs. The recipient (e.g., operator core network 110) may use the header information to authenticate a browser-based session and possibly to bill user 104.

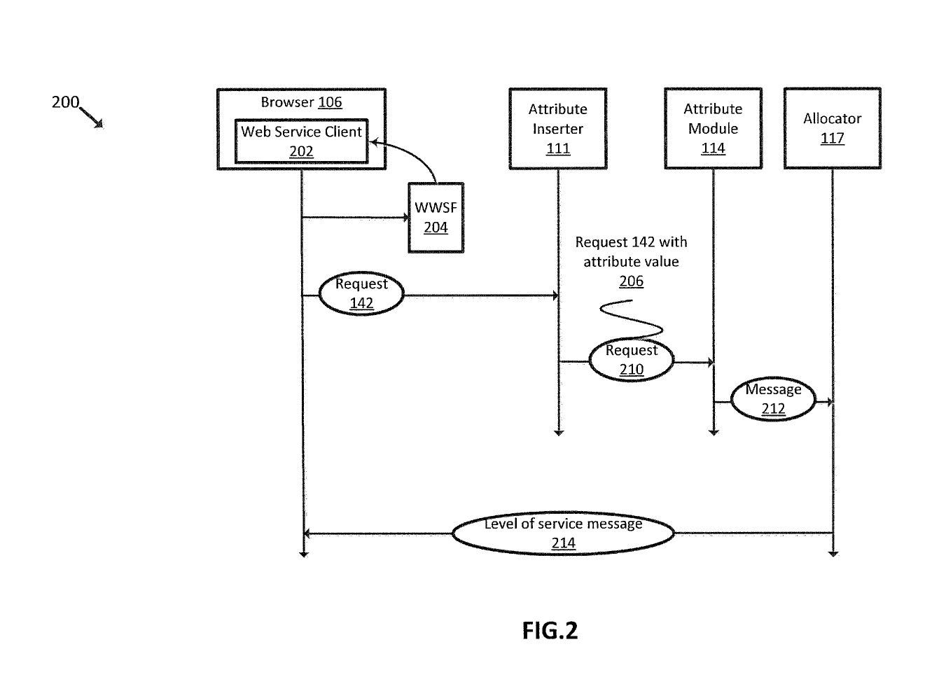

FIG. 2 is a partial call setup signaling diagram 200 illustrating the use of header information in request 142 to process the request, according to some embodiments. FIGS. 1 and 2 are discussed together to better explain the processing of request 142 using attribute information included in the header section of the request.

### A. Initiate Real-Time Communication Session for Web Service

Browser 106 may send a communication to operator core network 110 to initiate a real-time communication session for web service 132. Web service 132 may be interoperable with the IMS network. A web service client 202 may be spawned by a downloaded webpage running in browser 106. In an example, operator core network 110 is the IMS network, and web service client 202 is the WebRTC IMS Client (WIC). The first point of contact in the network for browser 106 may be a WebRTC Web Server Function (WWSF) 204, which hosts the IMS-aware webpage and can authenticate (using standard web mechanisms) web service client 202.

The IMS-aware webpage may be set up by the operator of operator core network 110 to launch the browser-based session. Different types of web technologies are available in browsers to perform real-time peer-to-peer messaging. In an example, operator core network 110 uses web socket technology to enable real-time peer-to-peer messaging between browsers. In such an example, the operator may provide a URL that corresponds to P-CSCF 112 and to the webpage that launches the browser-based session. P-CSCF 112 is capable of receiving a secure web socket connection originating from browser 106. A web socket is a client-server connection-oriented protocol that is supported by browsers and works over Transmission Control Protocol (TCP). A web socket connection may be able to penetrate firewalls and leverage Transport Layer Security (TLS) and therefore looks like a secure HTTP connection. The webpage sets up a web socket session with P-CSCF 112 when browser 106 points to the URL and downloads the webpage. In an example, the web page is hardcoded in the URL that is provided by the operator, and the webpage sends request 142 to operator core network 110.

WWSF 204 may provide a token and temporary IMS credentials so that browser 106 can authenticate with the IMS network without mechanisms such as GBA. The interface over which web service client 202 communicates with WWSF 204 may be referred to as the W1 interface, and the underlying transport may leverage standard web protocols (e.g., HTTP 1.1-based).

B. Insert Attribute Value into Header

Browser sends request 142 to operator core network 110. Before request 142 reaches P-CSCF 112, the request is received by attribute inserter 111, which is located in operator core network 110. Attribute inserter 111 may be located at, for example, the Internet access point or the mobile web proxy. Attribute inserter 111 receives request 142 and inserts an attribute value 206 into the header section of request 142. The attribute value is assigned to user equipment 102 and is device-identifying information. In an example, the attribute is a telephone number, and the attribute value is the telephone number that is assigned to user equipment 102. In FIG. 2, attribute inserter 111 generates a request 210 based on request 142. In an example, request 210 is request 142 with attribute value 206 inserted into the header section of request 142.

In an example, attribute inserter 111 inserts attribute value 206 into the header section by inserting an attribute header field (e.g., MatchAttribute) for the attribute and a value of the attribute into the header section. If the attribute is a telephone number, attribute inserter 111 may insert “<MatchAttribute: “123-456-789”> into the header section of request 142, where “123-456-789” is the telephone number assigned to user equipment 102. In another example, the attribute header field is already included in the request but its value is empty (e.g., “<MatchAttribute: “ ”>, where “123-456-789” is the telephone number assigned to user equipment 102. In this example, attribute inserter 111 may update the value of the attribute header field such that “<MatchAttribute: “123-456-789” is in the header section of request 142. The empty value may indicate that no attribute information is available at the moment for the user device. Attribute inserter 111 generates request 210 by inserting the appropriate attribute/attribute value information into the header section of request 142

Upon receiving request 210, P-CSCF 112 may be the same P-CSCF or different P-CSCF entity that registered/registers user equipment 102. P-CSCF 112 may be unknowledgeable of whether request 142 is from a valid subscriber, the data plan to which user equipment 102 is subscribed, and whether request 142 is a request to establish a real-time communication session (e.g., WebRTC session).

C. Match Attribute Value with Currently Registered User Equipment

Referring back to FIG. 1, P-CSCF 112 includes set of IMPUs 115 and an attribute module 114. Attribute module 114 may match attribute value 206 with an IMS registration. It may be challenging to match the IMS client authentication with the incoming browser-based session, assuming that in-band identifying information (e.g., HTTP/SIP digest) originating from the browser is not deemed as trustworthy. It may be desirable to use header enrichment (e.g., in P-CSCF 112) to draw a correspondence between a successfully-registered IMS client and incoming web traffic from the same user equipment.

Attribute module 114 may access the IMS registration status of the user equipment that is assigned attribute value 206. Accordingly, a network entity may leverage the information that it has regarding user equipment that is registered with operator core network 110 and match one level of identification (e.g., IMS registration) with another level of identification (e.g., attribute value 206). In an example, attribute module 114 ties IMS client authentication with browser-originated traffic.

In an embodiment, attribute module 114 (included in P-CSCF 112) receives request 210 and determines whether it includes a header field including attribute value 206. If the attribute value 206 is the telephone number assigned to user equipment 102, attribute module 114 may search the header section of request 210 for a header field corresponding to a telephone number. If attribute module 114 finds the header field corresponding to a telephone number, attribute module 114 reads the attribute value.

In an example, attribute module 114 identifies attribute value 206 in request 210, and determines, based on attribute value 206, whether user equipment 102 is currently registered with operator core network 110. When P-CSCF 112 receives a web request (e.g., request 210), attribute module 114 may parse the header information in request 210 to search for attribute value 206 and determine whether a user equipment assigned attribute value 206 is currently registered with operator core network 110.

In an example, attribute module 114 searches for attribute value 206 in set of IMPUs 115 to determine whether a user equipment assigned attribute value 206 is currently registered with operator core network 110. In another example, attribute module 114 sends a request to an operator database to determine whether a user equipment assigned attribute value 206 is currently registered with operator core network 110.

Additionally, request 210 includes attribute value 206 that identifies user equipment 102. Accordingly, P-CSCF 112 may use this information (e.g., the telephone number) to bill user 104 for the telephone call made in the browser-based session.

### D. Level of Service Based on Registration Status of User Equipment

Referring back to FIG. 1, P-CSCF 112 includes the allocator 117 that determines, based on whether user equipment 102 is currently registered with operator core network 110, a level of service to allocate for the browser-based session. In FIG. 2, attribute module 114 sends a message 212 to allocator 117, where message 212 indicates whether user equipment 102 is currently registered with operator core network 110. If message 212 indicates that user equipment 102 is currently registered with operator core network 110, allocator 117 may look up user equipment 102's data plan to determine, for example, information that is specific to user 104 (e.g., user 104's data cap and QoS).

If the user equipment assigned attribute value 206 is currently registered with operator core network 110, user equipment 102 has already been authenticated by and is currently registered with operator core network 110 (e.g., at the IMS level). Accordingly, user equipment 102 has already provided the subscriber credentials derived from UICC 108, which is typically a secure physical device that is difficult to spoof. In contrast, if no user equipment that is assigned attribute value 206 is currently registered with operator core network 110, user equipment 102 has not been authenticated by and is not currently registered with operator core network 110. The operator may not want to guarantee any level of service to user equipment 102 because it is not currently registered with operator core network 110.

Allocator 117 may determine, based on whether user equipment 102 is currently registered with operator core network 110, to allocate different levels of service in the network. Allocator 117 sends a level of service message 214 to browser 106, where level of service message 214 indicates the level of service that operator core network 110 will allocate for the browser-based session (if the session is established).

In response to determining that the user equipment assigned attribute value 206 is currently registered with operator core network 110, allocator 117 may fully authenticate the browser-based session for web service 132. Full authentication may refer to an offering of all possible IMS-interoperability services (e.g., cellular QoS, media transcoding, and routing to other IMS clients). For example, allocator 117 may determine to allocate a “full level” of service by providing all possible IMS-interoperability services.

In contrast, in response to determining that the user equipment assigned attribute value 206 is not currently registered with operator core network 110, allocator 117 may partially authenticate the browser-based session for web service 132. Partial authentication can result in withholding particular interoperability services (e.g., cellular QoS). Partial authentication may be based on web-transmitted credentials (e.g., temporary IMS identifiers or token-based authentication schemes). Accordingly, operators have the discretion to partially authenticate browser-based sessions and only allow sensitive operator-managed services (e.g., cellular QoS to WebRTC sessions) running on a user equipment that has already been authenticated with operator core network 110 (e.g., the cellular IMS network) using SIM-based credentials.

Authentication in the context of WebRTC that leverages IMS AKA along with header enrichment may provide a mechanism of authenticating a WebRTC session along with authenticating the subscriber UE without requiring browser extensions such as GBA. By leveraging an enhanced WebRTC-targeted IMS network element (e.g., P-CSCF 112), it is possible to leverage operator-controlled web authentication (e.g., header enrichment) along with IMS AKA. Moreover, if additional authentication information is desired such as standard web IP-administered tokens, then that would serve to compliment header enrichment and IMS AKA for multifactor authentication in a WebRTC deployment.

In another example, in response to determining that the user equipment assigned attribute value 206 is not currently registered with operator core network 110, allocator 117 may block the web service or browser-based session and not allow the real-time peer-to-peer communication (e.g., voice call) to take place.

In another example, in response to determining that the user equipment assigned attribute value 206 is not currently registered with operator core network 110, level of service message 214 may indicate that user equipment 102 has not yet registered with operator core network 110. In an example, operator core network 110 is the IMS network, and IMS client authentication and web-based authentication are not temporally synchronized. Accordingly, user equipment 102 may be unable to authenticate fully with the network as IMS client registration may not have completed before request 142 is received by P-CSCF 112. In this example, web service 132 may leverage information from any response by P-CSCF 112.

For example, P-CSCF 112 may send a message to browser 106, where the message indicates that IMS client authorization has not completed and the session should be reinitialized after a certain temporal back off period if QoS is desired. A back off procedure may be undesirable for a WebRTC service, but the web application knowing the reason for denial of full authentication can alert end user 104 accordingly. Browser 106 may continue to place the call without any QoS guarantees or may request approval from user 104 to place the call without any QoS guarantees. One example is a dialog box alerting user 104 that QoS has not been granted, and then requesting whether the user would like to retry the request or accept a session without QoS.

Allocator 117 may allocate the level of service for the browser-based session, where the level of service is dependent on whether the user equipment is currently registered with the operator core network. A particular level of service may specify the bandwidth or data transfer rate that will be allocated for the browser-based session.

It should be understood that the “matching” of authentication requests between registration client 109 (e.g., IMS client) and browser 106 (e.g., web service client 202) is not necessarily a prerequisite to an operator authenticating an IMS web service. For example, the operator may decide to authenticate a WebRTC session without IMS AKA. If, however, an operator policy for offering cellular QoS is dependent on IMS authentication being complete then leveraging header enrichment provides the operator the option to do so. Based on successful IMS registration, P-CSCF 112 may verify a header-enriched web request 142 from browser 106.

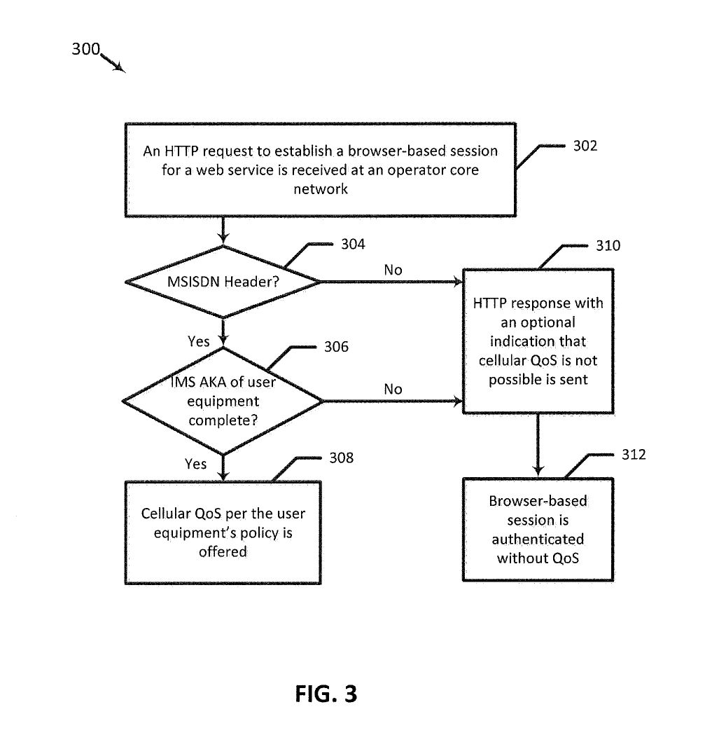

FIG. 3 is a simplified flowchart illustrating a method 300 for determining a level of service to allocate for a browser-based session, according to some embodiments. Method 300 is not meant to be limiting and may be used in other applications.

In FIG. 3, method 300 includes blocks 302-312. In a block 302, an HTTP request to establish a browser-based session for a web service is received at an operator core network. In an example, operator core network 110 receives request 142 to establish a WebRTC session, and P-CSCF 112 only checks on the status of IMS registration when an incoming web request related to initiation of a WebRTC session is received.

In a block 304, it is determined whether the HTTP request has a Mobile Station International Subscriber Directory Number (MSISDN) header in the header section of the request. An MSISDN is a number uniquely identifying a subscription in a Global System for Mobile Communications (GSM) or a Universal Mobile Telecommunications System (UMTS) mobile network. In an example, attribute inserter 111 inserts the MSISDN header into the header section of the HTTP request, and attribute module 114 determines whether HTTP requests have an MSISDN header. In this example, based on the presence of an MSISDN header, P-CSCF 112 can determine a level of service to allocate for the browser-based session. P-CSCF 112 may choose to authenticate the WebRTC session fully or partially.

If the HTTP request has an MSISDN header, process flow proceeds to a block 306, in which it is determined whether the IMS AKA of the user equipment is complete. In an example, attribute module 114 determines whether the IMS AKA of user equipment 102 is complete. If the IMS AKA, of the user equipment is complete, process flow proceeds to a block 308, in which cellular QoS per the user equipment's policy is offered. In an example, allocator 117 determines user equipment 102's policy and offers to allocate the cellular QoS based on the policy. For example, allocator 117 may determine to provide the same level of service that the subscriber would have for a typical voice call.

If the HTTP request does not have an MSISDN header or if the IMS AKA of the user equipment is not complete, process flow proceeds from blocks 304 or 306 to a block 310, in which the HTTP response with an optional indication that cellular QoS is not possible is sent to browser 106. In an example, the HTTP response with an optional indication that cellular QoS is not possible is included in level of service message 214 (in FIG. 2).

From block 310, process flow proceeds to a block 312, in which the browser-based session is authenticated without QoS. In an example, the browser-based session is an IMS WebRTC session that is authenticated without QoS. Accordingly, the user is still able to make the call, but is warned that the operator does not guarantee a QoS if the call is placed.

It is understood that additional processes may be inserted before, during, or after blocks 302-312 discussed above. It is also understood that one or more of the blocks of method 300 described herein may be omitted, combined, or performed in a different sequence as desired.

If request 142 does not leave the operator core network 110 (e.g., the recipient server is behind the operator firewall), then the attribute/device-identifying information in the header can be assumed to be uncompromised. Accordingly, request 142 may be an unencrypted request to P-CSCF 112 that does not cross a Network Access Translation (NAT) or firewall.

Situations may exist, however, in which header enrichment may be unreliable or not possible. In an example, if the recipient of the HTTP transaction is outside of the operator firewall, a possibility exists that middle boxes may compromise or simply fail to forward the identifying information in the header. As such, header enrichment may be unreliable when NAT or firewalls are in the communications path between browser 106 and P-CSCF 112. This may, however, result in partial authentication. Additionally, if NAT traversal occurs, the cellular network operator may be unable to offer QoS because user equipment 102 may be roaming or trying to access services over an alternate air interface technology such as Wi-Fi. NAT traversal occurs in Wi-Fi networks. For example, if user 104 attempts to place a WebRTC call at home over the home Wi-Fi modem (e.g., 802.11 access point), QoS may not make a huge difference and/or header enrichment may not work because the traffic may go through the Wi-Fi network and user equipment 102 may not have performed typical cellular registration through the Wi-Fi network.

In another example, if the HTTP transaction is over TLS (e.g., a secure socket), header enrichment may not be possible without breaking the secure connection. For example, if communications between web service client 202 (e.g., WIC) and P-CSCF 112 are over a secure web socket connection, web service client 202 may send a web request to P-CSCF 112 over an unencrypted transport such that P-CSCF 112 can receive a request with an enriched header. After this initial request, all subsequent signaling can go over a secure socket. If header enrichment has occurred on a web request, then it may be suitable to avoid a secure socket altogether for subsequent signaling as the underlying link layer (e.g., cellular) may be encrypted.

In another example, if user equipment 102 itself is behind a NAT, it may not be possible to receive the necessary information in the operator network that would uniquely identify the origin of the HTTP transaction. In the case of offering operator-managed services such as cellular QoS to WebRTC sessions however, the above situations may not apply.

It may be desirable to determine a level of service to allocate for the browser-based session independent of the header information, as discussed above.

### IV. IP Address Tied to Web Traffic

In some embodiments, the attribute is an IP address, and the attribute value is the IP address assigned to user equipment 102. In an example, operator core network 110 ties SIP registration to the IP address assigned to user equipment 102 for its data traffic. In this example, attribute module 114 may tie IMS client authentication with browser-originated traffic. By tying the IMS registration to an IP address assigned to user equipment 102, it may be unnecessary for the operator to look at the header information, as discussed above. Rather, the operator may identify the IP address from where the web traffic is coming.

When user equipment 102 opens a data session and is assigned an IP address, this IP address is stored in the central IMS user database associated with HSS 120. When S-CSCF 118 receives any subsequent SIP registration messages, S-CSCF 118 matches the SIP message IP header with the IP address stored in HSS 120 for further authentication.

In the context of WebRTC, GPRS-IMS-Bundled Authentication (GIBA) may be leveraged. In this case, P-CSCF 112 may ensure that the SIP messaging and IP address passed to S-CSCF 118 is identical to the IP address and embedded SIP message received from browser 106. S-CSCF 118 may verify that the browser-based session matches the IMS client registration. If P-CSCF 112 can access HSS 120 directly, the verification of IMS client registration can take place within P-CSCF 112 using GIBA with the benefit being that spurious registration messages are not passed along to S-CSCF 118.

### V. Example Method

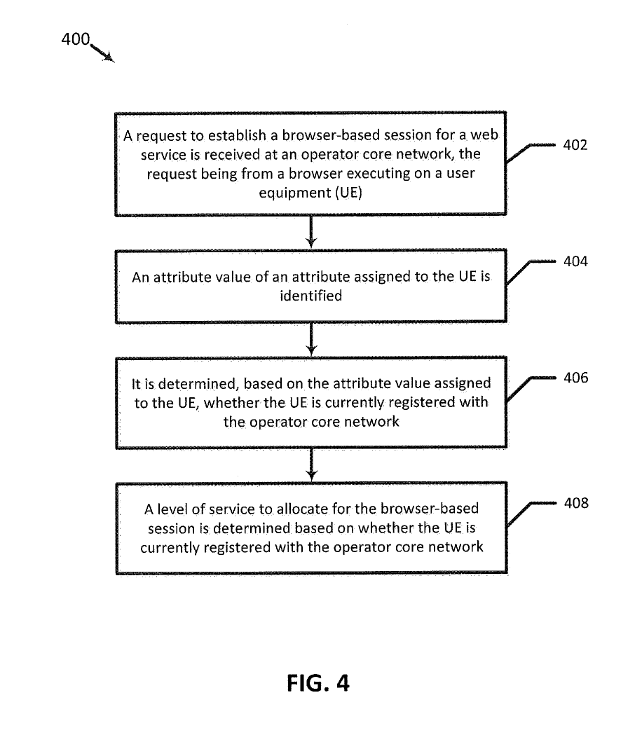

FIG. 4 is a simplified flowchart illustrating a method 400 of determining a level of service to allocate for a browser-based session, according to some embodiments. Method 400 is not meant to be limiting and may be used in other applications.

Method 400 includes blocks 402-408. In a block 402, a request to establish a browser-based session for a web service is received at an operator core network, the request being from a browser executing on a user equipment (UE). In an example, P-CSCF 112 receives, at operator core network 110, request 142 to establish a browser-based session for web service 132, request 142 being from browser 106 executing on user equipment 102.

In a block 404, an attribute value of an attribute assigned to the UE is identified. In an example, attribute module 114 identifies attribute value 206 of an attribute assigned to user equipment 102. In a block 406, it is determined, based on the attribute value assigned to the UE, whether the UE is currently registered with the operator core network. In an example, attribute module 114 determines, based on attribute value 206 assigned to user equipment 102, whether user equipment 102 is currently registered with operator core network 110.

In a block 408, a level of service to allocate for the browser-based session is determined based on whether the UE is currently registered with the operator core network. In an example, allocator 107 determines, based on whether user equipment 102 is currently registered with operator core network 110, a level of service to allocate for the browser-based session.

It is also understood that additional processes may be performed before, during, or after blocks 402-408 discussed above. It is also understood that one or more of the blocks of method 400 described herein may be omitted, combined, or performed in a different sequence as desired.

As discussed above and further emphasized here, FIGS. 1-4 are merely examples, which should not unduly limit the scope of the claims. For example, although attribute module 114 and allocator 117 are illustrated as residing in P-CSCF 112, this is not intended to be limiting and attribute module 114 and/or allocator 117 may reside in any of the other functional entities (e.g., I-CSCF 116 or S-CSCF 118).

### VI. Example Wireless Device

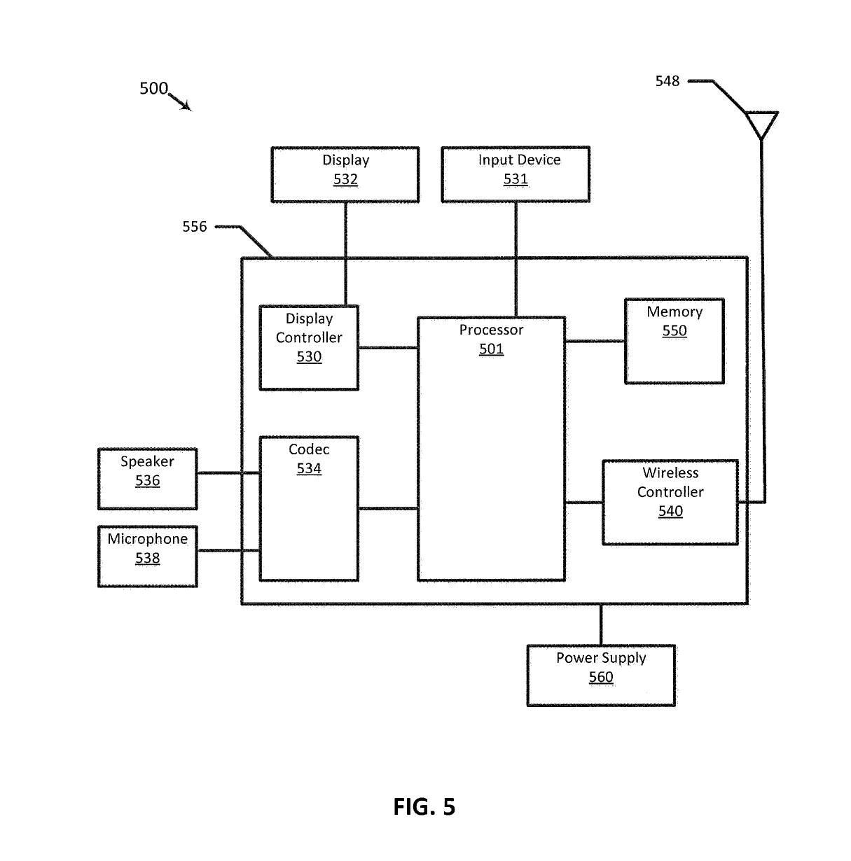

FIG. 5 is a block diagram illustrating a wireless device 500, according to some embodiments. Wireless device 500 includes a processor 501, such as a digital signal processor (DSP) to process instructions to facilitate communication between wireless device 500 and operator core network 110 or web service 132. In an example, processor 501 processes instructions according to methods 300 and/or 400. User equipment 102 may be a cellular-enabled device that is implemented as wireless device 500.

FIG. 5 also shows a display controller 530 that is coupled to processor 501 and to a display 532. A coder/decoder (CODEC) 534 may also be coupled to processor 501. A speaker 536 and a microphone 538 may be coupled to CODEC 534. Additionally, a wireless controller 540 may be coupled to processor 501 and to a wireless antenna 548. In some embodiments, processor 501, display controller 530, memory 550, CODEC 534, and wireless controller 540 are included in a system-in-package or system-on-chip device 556.

In some embodiments, input device 531 and a power supply 560 are coupled to system-on-chip device 556. Moreover, in some embodiments, as illustrated in FIG. 5, display 532, input device 531, speaker 536, microphone 538, wireless antenna 548, and power supply 560 are external to system-on-chip device 556. Each of display 532, input device 531, speaker 536, microphone 538, wireless antenna 548, and power supply 560 may be coupled to a component of system-on-chip device 556, such as an interface or a controller. The user of wireless device may communicate with another user by speaking into microphone 538 or seeing the other user via display 532.

The user may use input device 531 to point the browser to a URL of a webpage that initiates a browser-based session. The browser-based session may be a real-time peer-to-peer communication session. After this communication session is established, the user may speak into microphone 538 to talk to a user at the other end of the communication line and may hear the other user via speaker 536. Operator core network 110 may determine, based on whether wireless device 500 is currently registered with operator core network 110, a level of service to provide the user for the browser-based session.

Those of skill would further appreciate that the various illustrative logical blocks, configurations, modules, circuits, and steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The blocks of a method described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An example storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims. Thus, the present disclosure is limited only by the claims.

What is claimed is:

1. A method of determining a level of service to allocate for a browser-based session, comprising:
receiving, at an operator core network, a request to establish a browser-based session for a web service, the request being from a browser executing on a user equipment (UE);
identifying an attribute value of an attribute assigned to the UE;
determining, based on the attribute value assigned to the UE, whether the UE is currently registered with the operator core network; and
determining, based on whether the UE is currently registered with the operator core network, a level of service to allocate for the browser-based session.

2. The method of claim 1, further comprising:
allocating the level of service for the browser-based session, the level of service being dependent on whether the user equipment is currently registered with the operator core network.

3. The method of claim 1, further comprising:
in response to determining that the UE is currently registered with the operator core network, fully authenticating the browser-based session.

4. The method of claim 1, further comprising:
in response to determining that the UE is not currently registered with the operator core network, partially authenticating the browser-based session.

5. The method of claim 1, further comprising:
providing a message to the browser, the message indicating the level of service to allocate for the browser-based session.

6. The method of claim 1, further comprising:
registering the UE with the operator core network.

7. The method of claim 6, further comprising:
receiving subscriber credentials derived from a SIM card located in the UE; and
determining, based on the subscriber credentials, whether to register the UE.

8. The method of claim 6, wherein the registering the UE with the operator core network includes registering the UE using IMS AKA.

9. The method of claim 1, wherein the browser-based session is a real-time peer-to-peer communication session.

10. The method of claim 1, wherein the request is a hypertext transfer protocol (HTTP) request that includes a header section.

11. The method of claim 10, further comprising:
inserting the attribute value into the header section.

12. The method of claim 10, wherein the attribute is a telephone number and the attribute value is the telephone number assigned to the UE.

13. The method of claim 10, wherein the identifying an attribute value includes identifying the attribute value included in the header section.

14. The method of claim 10, wherein the determining whether the UE is currently registered with the operator core network includes:
determining whether a UE assigned the attribute value is registered with the operator core network;
in response to determining that no UE assigned the attribute value is registered with the operator core network, determining that the UE is not currently registered with the operator core network; and
in response to determining that the UE assigned the attribute value is registered with the operator core network, determining that the UE is currently registered with the operator core network.

15. The method of claim 1, wherein the attribute is an Internet Protocol (IP) address and the attribute value is the IP address assigned to the UE.

16. The method of claim 15, wherein the determining whether the UE is currently registered with the operator core network includes:
determining whether a UE assigned the attribute value is registered with the operator core network;
in response to determining that a UE assigned the attribute value is registered with the operator core network, determining that the UE is currently registered with the operator core network; and
in response to determining that no UE assigned the attribute value is registered with the operator core network, determining that the UE is not currently registered with the operator core network.

17. A system for determining a level of service to allocate for a browser-based session, comprising:
an attribute module that receives, at an operator core network, a request to establish a browser-based session for a web service, identifies an attribute value assigned to a user equipment (UE), and determines, based on the attribute value assigned to the UE, whether the UE is currently registered with the operator core network, wherein the request is from a browser executing on the UE; and
an allocator that determines, based on whether the UE is currently registered with the operator core network, a level of service to allocate for the browser-based session.

18. The system of claim 17, wherein the allocator allocates the level of service for the browser-based session, and wherein the level of service is dependent on whether the user equipment is currently registered with the operator core network.

19. The system of claim 17, wherein the browser-based session is a real-time peer-to-peer communication session.

20. The system of claim 17, wherein the UE is a smartphone, tablet, laptop, or personal digital assistant.

21. The system of claim 17, wherein the UE is subscribed to the operator core network.

22. The system of claim 17, wherein the operator core network is the IP Multimedia Subsystem (IMS) network.

23. The system of claim 17, further comprising:
a P-CSCF that registers, based on subscriber credentials derived from a SIM card located in the UE, the UE with the operator core network.

24. The system of claim 17, wherein the request includes a header section, and wherein the attribute module identifies the attribute value included in the header section and determines whether a UE assigned the attribute value is registered with the operator core network.

25. The system of claim 24, further comprising:
an attribute inserter that inserts the attribute value into the header section.

26. The system of claim 24, wherein the attribute module determines whether a UE assigned the attribute value is registered with the operator core network, wherein in response to determining that a UE assigned the attribute value is registered with the operator core network, the attribute module determines that the UE is currently registered with the operator core network, and wherein in response to determining that no UE assigned the attribute value is registered with the operator core network, the attribute module determines that the UE is not currently registered with the operator core network.

27. The system of claim 17, wherein the attribute module determines whether a UE assigned the attribute value is registered with the operator core network, wherein in response to determining that a UE assigned the attribute value is registered with the operator core network, the attribute module determines that the UE is currently registered with the operator core network, and wherein in response to determining that no UE assigned the attribute value is registered with the operator core network, the attribute module determines that the UE is not currently registered with the operator core network.

28. The system of claim 27, wherein the attribute is an Internet Protocol (IP) address and the attribute value is the IP address assigned to the UE.

29. A computer-readable medium having stored thereon computer-executable instructions for performing operations, comprising:
receiving, at an operator core network, a request to establish a browser-based session for a web service, the request being from a browser executing on a user equipment (UE);
identifying an attribute value of an attribute assigned to the UE;
determining, based on the attribute value assigned to the UE, whether the UE is currently registered with the operator core network; and
determining, based on whether the UE is currently registered with the operator core network, a level of service to allocate for the browser-based session.

30. An apparatus for determining a level of service to allocate for a browser-based session, comprising:
means for receiving a request to establish a browser-based session for a web service, the request being from a browser executing on a user equipment (UE);
means for identifying an attribute value of an attribute assigned to the UE;
means for determining, based on the attribute value assigned to the UE, whether the UE is currently registered with the operator core network; and
means for determining, based on whether the UE is currently registered with the operator core network, a level of service to allocate for the browser-based session.
